(19) United States
(12) Patent Application Publication
(10) Pub. No.: US 2007/0166649 A1
(43) Pub. Date: Jul. 19, 2007

(54) METHOD OF FORMING A MICRO DEVICE

(76) Inventor: Cheng-Hung Yu, Kao-Hsiung City (TW)

Correspondence Address: NORTH AMERICA INTELLECTUAL PROPERTY CORPORATION, P.O. BOX 506, MERRIFIELD, VA, 22116, US

(21) Appl. No.: 11/307,002

(22) Filed: Jan. 18, 2006

(51) Int. Cl. G03C 5/00

(52) U.S. Cl. 430/311

(57) ABSTRACT

A method of forming a micro device includes using a light source which has a first wavelength beaming to a photo resist which is suited for a second wavelength, developing the photo resist which is suited for the second wavelength to form a plurality of sensitization block, and performing a heating process on the sensitization block to form a micro device.

### BACKGROUND OF THE INVENTION

1. Field of the Invention

The present invention relates to a method of forming a micro device, and more particularly, to a method of forming a micro device that has a photo resist specifically made for a second wavelength, but is exposed to a first wavelength light source.

2. Description of the Prior Art

CMOS image sensors (CISs) and charge-coupled devices (CCDs) are the optical circuit components for utilization with light signals and their representation as digital signals. CISs and CCDs are used in the prior art. These two components widely applied to many devices, including: scanners, video cameras, and digital still cameras. CCDs use is limited in the market due to price and the volume considerations. As a result, CISs enjoy greater popularity in the market.

The CIS is manufactured utilizing the prior art semiconductor manufacture process. This process helps to decrease the cost and the component size. It applies to digital products such as personal computer cameras such as Web cams and digital cameras. Currently, CIS can be classified into two types: line type and plane type. The line type CIS applies to scanners. The plane type CIS applies in digital cameras.

Please refer to FIGS. 1-2. FIGS. 1-2 show the CIS manufacturing process according to the prior art. As shown in FIG. 1, a semiconductor substrate 100 includes a plurality of shallow trench isolations (STI) 120 and a plurality of photodiodes 122. Each photodiode 122 connects electrically to at least one MOS transistor (not shown). The STI 120 is an insulator between these two adjacent photodiodes 122 for preventing the photodiode 122 from shorting with other components.

In the prior art, a planarizing layer 102 is formed on the semiconductor substrate 100 for covering a photodiode 122 and MOS transistor (not shown). A dielectric layer 104 and a plurality of pattern metal layers 124 are formed on the dielectric layer 104. Additionally, a metal layer 124 and a metal layer 126 are formed on each STI 120 to avoid covering each photodiode 122. The incident light (not shown) is gathered to the photodiode 122 without cross talk caused by the scattering. The metal layers 124, 126 are the part of the multilevel interconnects in the circus of MOS transistor. Then, a passivation layer 108 is formed on the dielectric layer 106, and a silicon nitride layer is doped for avoiding mist and other impurities from affecting the components.

Then, a color filter array (CFA) 128, which is combined by R/G/B filter patterns, is formed on the silicon nitride layer 110. A spacer layer 112 is formed on the color filter array 128. A resin layer (not shown), which has the photoactive compound, is formed on the color filter array 128. In the prior art, the light source of the exposure process is a 365 nm wavelength UV (I-line). In the current technology, the micro-lens manufacture of the CIS most often uses I-line as the light source of the exposure process. After the 365 nm wavelength UV exposure and development, a sensitization block 130 is formed to line up an array. The width of the space 136 between the sensitization block 130 and the adjacent sensitization block 130 is decided by the exposure resolution of the sensitization block 130. Given the current technology, the space cannot be less than 0.2 μm. In fact, the prior art still maintains a 0.4 μm distance between the sensitization blocks.

Please refer to FIG. 2. After the sensitization block 130 is formed, a reflow process is performed. The CIS 140 is exposed to high temperature for 5-10 minuets. During the high temperature exposure, the resin material of the sensitization block 130 changes, specifically, the shape of the resin layer is transformed by the high temperature of the reflow process. The sensitization block 130 is a square in FIG. 1, and then, it becomes a micro-lens 134, which is almost a semicircle arc. After the reflow process, CIS 140 is finished.

Please notice the space 138 between two micro-lenses 134 in FIG. 2. Notice in certain aspect that this space is smaller than the space 136 between the two sensitization blocks 130 in FIG. 1 after the reflow process. This is caused by the resin material of the sensitization block 130 having changed shape by the heat and surface tension forces. Please refer to FIG. 3. FIG. 3 is a bird's eye view of SEM photograph showing the sensitization block becoming the micro-lens after the reflow process according to the prior art. FIG. 3 is the same as FIGS. 1 -2 but FIG. 3 shows the sensitization block 130 and the micro-lens 134 from the lateral side. The space 136 between the two sensitization blocks 130 is formed, after 365 nm wavelength UV exposure and development. The sensitization block 130 is almost a square. After the reflow process 300, the space 138 is formed between two micro-lenses 134. It is obvious the space 138 is smaller than the space 136 in FIG. 3. The four sides of the micro-lens 134 are semicircle arcs. A 45° direction-space 142 of the micro-lens 134 can not decrease their width unlike the space 138 after the reflow process 300.

Please refer to FIG. 4. FIG. 4 is a lateral view of a SEM photograph of the micro-lens in FIG. 3. As shown in FIG. 4, the space 138 between two micro-lenses 134 in the prior art provided by the space 136 between two sensitization blocks 130 is for avoiding the sensitization block 130 to change shape after the prior art reflow process. If the width of the space 136 is too small, two sensitization blocks 130 will merge. Therefore, the prior art must save larger spaces 136 for avoiding the micro-lens shape to be changed. Additionally, two micro-lenses 134 must have a fixed distance. Therefore, in the prior art, the gapless micro-lens 134 without micro-lens mergence is impossible.

Another prior art micro-lens is disclosed. For example, U.S. Pat. No. 6,540,946 noted a CIS manufacture method. The feature of U.S. Pat. No. 6,540,946 involves the sensitization block being shot by UV ,before the reflow process. The purpose is for the sensitization material of the micro-lens to be bleaching by the UV, and the transmittance of the micro-lens thereby increases. Its manufacture method in other ways is like the general CIS manufacture method. A color filter array is formed and a spacer layer is formed on the color filter array. A resin layer having sensitization is formed on the spacer layer, after the exposure and the development, the sensitization block is formed. Then, the 350-430 nm UV is shot on the sensitization block to destroy the sensitization material of the micro-lens and to increase the transmittance. The reflow process is provided and the micro-lens is formed, and the micro-lens has higher transmittance. This technology could provide an increasing of the transmittance of the micro-lens, but it cannot achieve the purpose of providing gapless micro-lenses.

To synthesize the above-mentioned, in the prior art, the space between two micro-lenses of CIS is limited by the lithography resolution. The space between two sensitization blocks could not be less than 0.2 μm after 365 nm wavelength UV exposure. In addition, the micro-lens could merge after the reflow process. Therefore, the micro-lens 134 must have space. Nevertheless, the manufacture trend of the process window grows smaller and smaller. Many manufacture engineers study how to produce gapless micro-lens. Therefore, ways to decrease the space between two micro-lenses is an important issue in this domain.

### SUMMARY OF THE INVENTION

The claimed invention provides a method of forming a micro device to solve the above-mentioned prior art problem.

An embodiment of the claimed invention provides a method of forming a micro device. The method includes utilizing a light source which has a first wavelength beaming to a photo resist which is specifically made for a second wavelength, developing the photo resist which is suited for the second wavelength to form a plurality of sensitization blocks, and performing a heating process on the sensitization blocks to form a micro device.

Another embodiment of the claimed invention provides a method of forming a micro-lens. The method includes forming a sensitization layer, exposing the sensitization layer to a first wavelength UV, developing and forming a plurality of sensitization blocks, the sensitization block and an adjacent sensitization block having a sensitization block space, and performing a reflow process making the sensitization block become a micro-lens, the micro-lens and the adjacent micro-lens have no space, and thereby forming a gapless micro-lens.

As compared to the prior art, the claimed invention utilizes short wavelength UV as the exposure light source for exposure of the sensitization block. Thereby, the exposure transmittance increases and the space between two sensitization blocks decreases. Furthermore, the claimed invention uses short wavelength UV as the exposure light source, but uses a PAC resin layer for the photo resist. The PAC resin is specifically made for longer wavelengths. Therefore, the exposure time increases and simultaneously the sensitization block benefits from a process similar to curing. As a result, two sensitization blocks don't merge after the reflow process.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-2 are diagrams of the CIS manufacture process according to the prior art.

FIG. 3 is a SEM photograph of the sensitization block becoming the micro-lens after the reflow process according to the prior art.

FIG. 4 is a lateral view SEM photograph of the micro-lens shown in FIG. 3.

FIGS. 5-6 are diagrams of the CIS manufacture process according to the present invention.

FIG. 7 is a SEM photograph of the micro-lens according to the present invention.

FIG. 8 is a lateral view SEM photograph of the micro-lens shown in FIG. 7 according to the present invention.

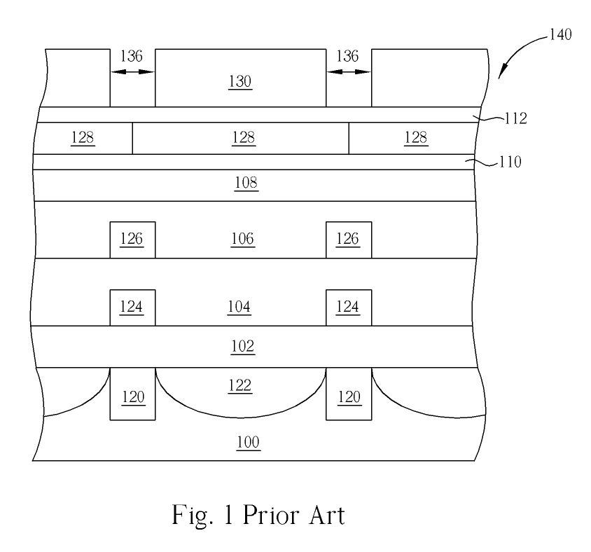

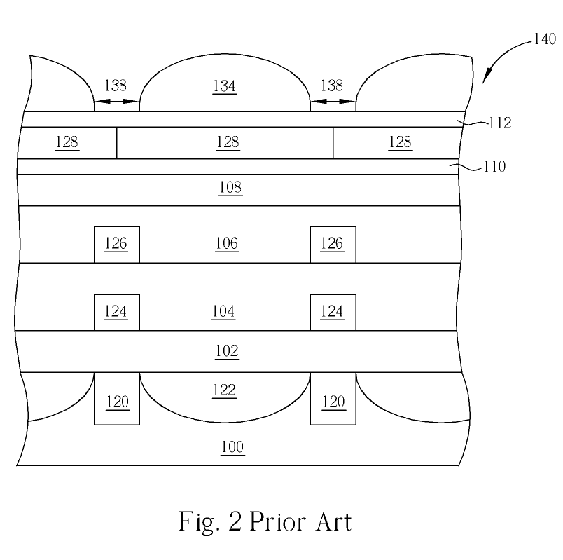

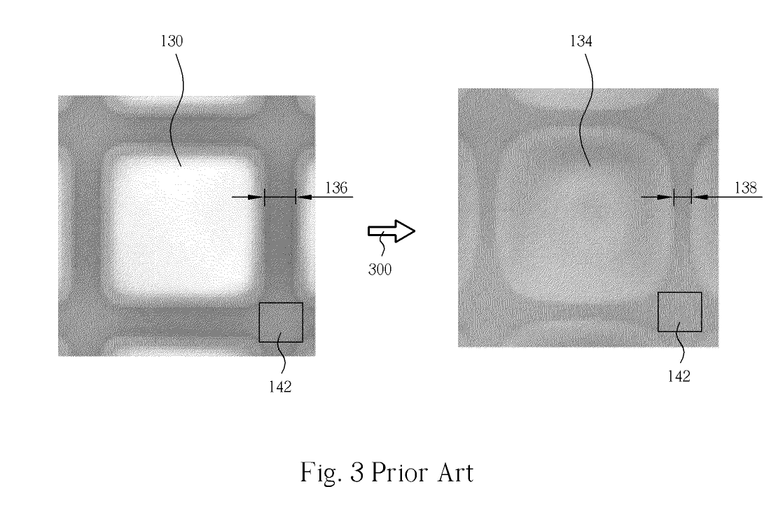

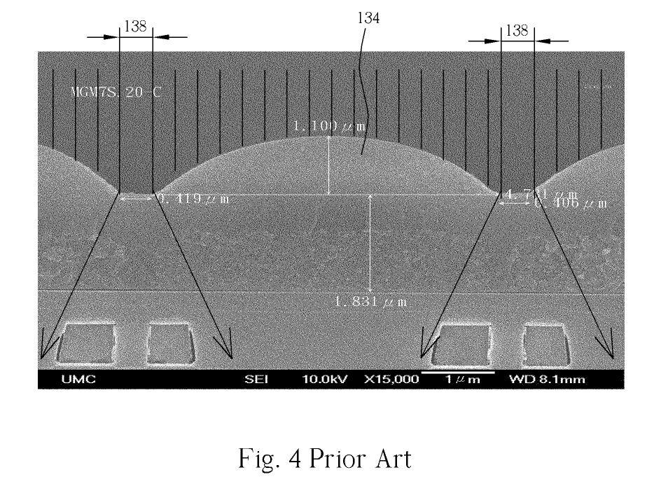

### DETAILED DESCRIPTION

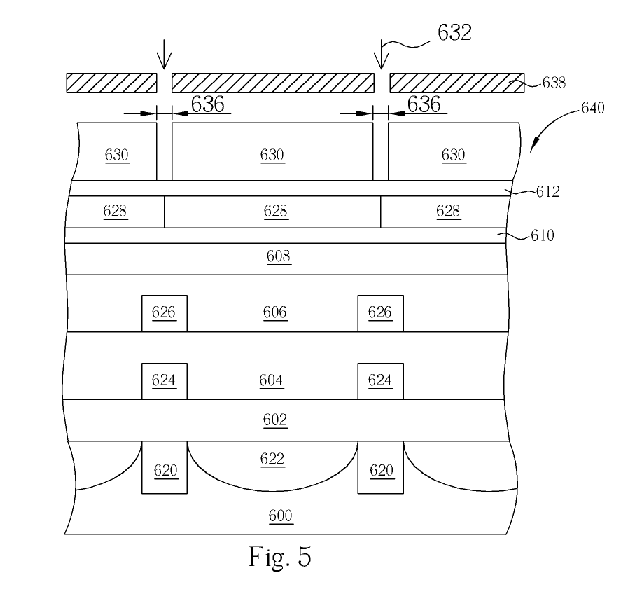

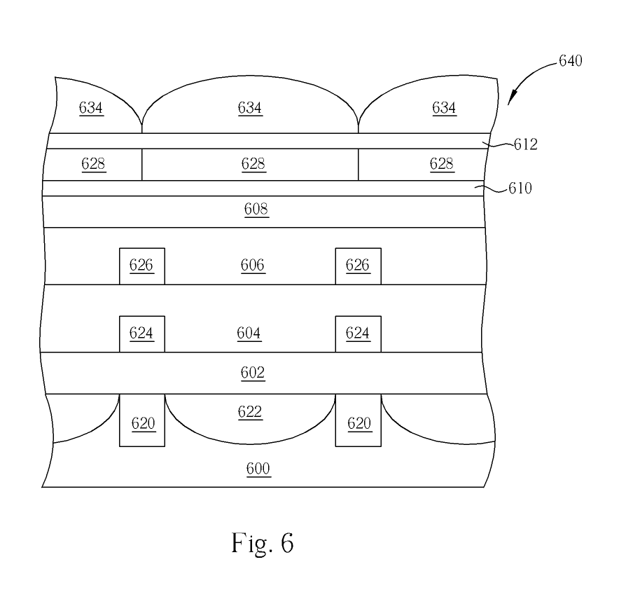

Please refer to FIGS. 5-6. FIGS. 5-6 are diagrams of the CIS manufacture process according to the present invention. As FIG. 5 shows, a semiconductor substrate 600 includes a plurality of shallow trench isolations (STI) 620 and a plurality of photodiodes 622. Each photodiode 622 connects electrically to at least one MOS transistor (not shown). The STI 620 is an insulator between these two adjacent photodiodes 622 for avoiding the photodiode 622 from shorting with other components.

Just like the prior art, a planarizing layer 602 is formed on the semiconductor substrate 600 for covering a photodiode 622 and MOS transistor (not shown). The dielectric layer 604 and a plurality of pattern metal layer 624 are formed on the dielectric layer 604. In addition, the metal layer 624 and the metal layer 626 are formed on each STI 620 for preventing each photodiode 622 from covering. The incident light (not shown) was gathered into the photodiode 622 without cross talk caused from the scattering. The metal layer 624, 626 are the part of the multilevel interconnects of the circus of MOS transistor. Next, the passivation layer 608 is formed on the dielectric layer 606 and the silicon nitride layer is doped for avoiding mist, and other impurities from affecting the components.

Then, a color filter array (CFA) 628, which is combined by R/G/B filter patterns, is formed on the silicon nitride layer 610. A spacer layer 662 is formed on the color filter array 628. A resin layer (not shown), which is made form the photoactive compound, is formed on the color filter array 628. In this embodiment, the resin layer includes resin (e.g.,: Novolak), the photoactive compound (PAC), and the solvent. Because the resin layer has PAC, the resin layer could be the photo resist. The composition of the resin layer is suited for the exposure light source of 365 nm wavelength UV (i.e., it is well suited for the I-line exposure in this industry). Next, a mask 638 and a short wavelength UV 632 is utilized as the exposure light source. After exposure and development, a sensitization block 630 is formed.

The exposure light source uses the short wavelength UV 632 that is shorter than 365 nm, which is the original sensitization wavelength of the resin layer. The short wavelength UV 632 could be 193-248 nm UV that is shorter than I-line wavelength such as 248 nm UV. That increases the exposure transmittance of the resin layer and the space 636 decreases to 0.2 μm. Because the resin layer is designed for 365 nm wavelength exposure light source, the resin layer is less photosensitive to the short wavelength UV 632 and the exposure time must be increased. The longer exposure time makes the short wavelength UV 632 beam the resin layer longer than the 365 nm UV beams to the resin layer as happens in the prior art. So, in this embodiment, the sensitization block 630 near the exposure is made by the longer exposure time. The surface and the surface material of the sensitization block 630 near the space are changed by an effect similar to curing. Then, as shown in FIG. 6, the micro-lens 634 made by the reflow process is easier to control the reflow distance. There is no space between two micro-lenses; two micro-lenses 634 do not merge. After the reflow process, CIS 640 is formed.

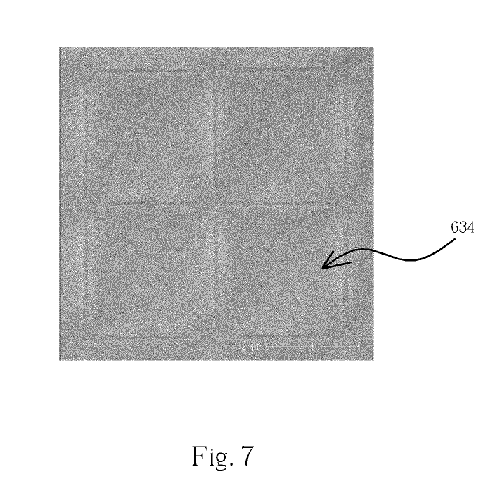

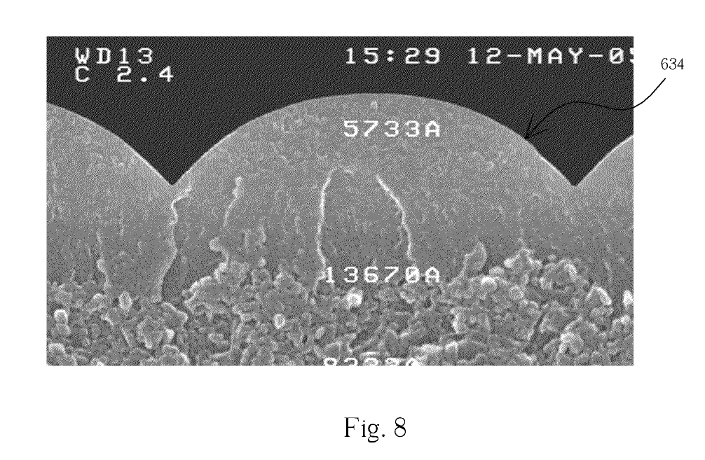

Please refer to FIG. 7. FIG. 7 is a SEM photograph of the micro-lens according to the present invention. FIG. 7 continues the condition of FIG. 6. FIG. 7 is the bird's eye view of the micro-lens 634. The micro-lens 634 is made by the sensitization block 630 after the reflow process, as FIG. 7 shows. Each micro-lens 634 is similar to a square. Even after the reflow process, the 45° direction-space of the micro-lens 634 can be very small, because the resin layer is suited for 365 nm wavelength UV exposes by 248 nm. There is almost no space between two micro-lenses. Please refer to FIG. 8. FIG. 8 is a lateral view of the SEM photograph of the micro-lens shown in FIG. 7 according to the present invention. As FIG. 8 shows, there is no space between two micro-lenses 634. Two micro-lenses 634 do not merge. The present invention uses 248 nm wavelength UV for exposing the resin layer (e.g., such as the photo resist) which has PAC suited for 365 nm wavelength UV. The sensitization block near the space under goes an effect similar to curing. Thereby, two sensitization blocks 630 will not merge after the reflow process. As is well know in the industry, the space width of two sensitization blocks 630 is counted by the tolerance space width of two micro-lenses after reflow process without mergence. Because the sensitization block 630 of the present invention is beamed by short wavelength UV, the sensitization block has the effect like curing, and two micro-lenses 634 do not merge. That means the space between two sensitization blocks could be smaller, and the gapless micro-lens could be formed after the reflow process of the sensitization block exposure process in the present invention. The gapless micro-lenses of the present invention can increase the fill factor of the micro-lenses to 100%, and the light-absorbed area of the micro-lenses can reach to 100% to develop the photosensitivity. Thus, the present invention has obvious effect in the small size CMOS.

It deserves to be mentioned, expect to the above-mentioned embodiment uses 248 nm wavelength UV exposes the resin layer such as the photo resist which has PAC suits for 365 nm wavelength UV. The present invention also could use a resin layer suits for a special wavelength UV, but the resin layer was exposed by the UV which has shorter wavelength than the special wavelength. This different of two wavelengths forms gapless component (ex: micro-lens). The present invention suits for every micro-lens of CIS, CCDs, and MEMS.

To compare with the prior art, the present invention uses 248 nm wavelength UV for exposure light source, so the space between two sensitization blocks decreases less than 0.2 μm. The prior art can only reach 0.4 μm, so the present invention has better resolution. Furthermore, the present invention uses 248 nm short wavelength UV for exposing the resin layer, such as the photo resist, which has PAC well suited for 365 nm wavelength UV. So, the exposure time increases, and the sensitization block near the space benefits from a process similar to curing after longer exposure time. As a result, the two sensitization blocks don't merge after the reflow process. Therefore, the present invention could make high resolution and gapless micro-lens, as shown in FIG. 8. In addition, the manufacture method of the present invention is simple, unlike U.S. Pat. No. 6,540,946 that requires two times the UV beams to increase transmittance. The present invention requires only a resin layer specifically made for a special wavelength UV. In other words, the resin layer exposed to the UV that has shorter wavelength than the special wavelength. In addition, one time of the UV beam on the sensitization block and longer exposure time make the exposure transmittance increase, and the gapless sensitization blocks are formed. U.S. Pat. No. 6,540,946 only can increase transmittance, but the present invention can increase the fill factor of the micro-lenses to 100% to develop the photosensitivity. So, the present invention is a simpler manufacture method and has better effect, when it compares to the prior art.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of forming a micro device comprising:
utilizing a light source that has a first wavelength beaming to a photo resist which is specifically made for a second wavelength;
developing the photo resist which is specifically made for the second wavelength to form a plurality of sensitization blocks; and
performing a heating process on the sensitization blocks to form a micro device.

2. The method of claim 1, wherein the micro device comprising the micro-lens of a CMOS image sensor (CIS).

3. The method of claim 1, wherein the micro device comprising the micro-lens of charge-coupled devices (CCDs).

4. The method of claim 1, wherein the light source which has the first wavelength is a first wavelength UV.

5. The method of claim 1, wherein the first wavelength is less than the second wavelength.

6. The method of claim 5, wherein the first wavelength comprising a 248 wavelength.

7. The method of claim 5, wherein the second wavelength comprising a 365 wavelength.

8. The method of claim 1, wherein the photo resist layer comprising a resin layer which has photoactive component (PAC).

9. The method of claim 8, wherein the resin layer which has photoactive component further comprising a solvent.

10. The method of claim 1, wherein the sensitization block and the adjacent sensitization block comprising a sensitization block space.

11. The method of claim 10, wherein the width of the sensitization block space is 0.2 μm.

12. The method of claim 10, wherein the width of the sensitization block space is less than 0.2 μm.

13. The method of claim 1, wherein the width of the micro device space comprises 0 μm.

14. The method of claim 1, wherein the heating process is a reflow process.

15. A method of forming a micro-lens comprising:
forming a sensitization layer;
exposing the sensitization layer by a first wavelength UV;
developing and forming a plurality of sensitization blocks, the sensitization block and the adjacent sensitization block have a sensitization block space; and
processing a reflow process to make the sensitization block become a micro-lens, the micro-lens and the adjacent micro-lens have no space, and forming a gapless micro-lens.

16. The method of claim 15, wherein the micro-lens comprising the micro-lens of a CMOS image sensor (CIS).

17. The method of claim 15, wherein the micro-lens comprising the micro-lens of a charge-coupled devices (CCDs).

18. The method of claim 15, wherein the sensitization layer comprising a resin layer specifically made for a second wavelength.

19. The method of claim 18, wherein the resin layer comprises a photoactive compound and a solvent.

20. The method of claim 18, wherein the first wavelength is less than the second wavelength.

21. The method of claim 20, wherein the first wavelength comprises a 248 wavelength.

22. The method of claim 20, wherein the second wavelength comprises a 365 wavelength.

23. The method of claim 15, wherein the width of the sensitization block space comprises 0.2 μm.

24. The method of claim 15, wherein the sensitization layer is a photo resist layer.
